(19) United States
(12) Patent Application Publication
(10) Pub. No.: US 2024/0088704 A1
(43) Pub. Date: Mar. 14, 2024

(54) CHARGE SUPPORT SYSTEM, CHARGE SUPPORT METHOD, AND CONTROL PROGRAM

(71) Applicant: TOYOTA JIDOSHA KABUSHIKI KAISHA, Toyota-shi (JP)

(72) Inventors: Taizo MASUDA, Yokohama-shi (JP); Yasunobu SEKI, Nisshin-shi (JP); Hiroki AWANO, Susono-shi (JP); Tomoko NAKAMURA, Naka-gun (JP); Tsuyoshi KANEKO, Nisshin-shi (JP); Kosuke YONEKAWA, Nisshin-shi (JP)

(73) Assignee: TOYOTA JIDOSHA KABUSHIKI KAISHA, Toyota-shi (JP)

(21) Appl. No.: 18/229,303

(22) Filed: Aug. 2, 2023

(30) Foreign Application Priority Data
Sep. 8, 2022 (JP) 2022-142639

(51) Int. Cl. H02J 7/35; B60R 16/033; H02J 7/00

(52) U.S. Cl. CPC H02J 7/35; B60R 16/033; H02J 7/00047; H02J 7/0048; B60L 53/51

(57) ABSTRACT

A charge support system including: a detection unit configured to detect that a vehicle is scheduled to be parked for a predetermined period or longer; an acquisition unit configured to acquire information about a charging of a storage battery when the detection unit detects that the vehicle is scheduled to be parked for a predetermined period or longer; a determination unit configured to determine, based on the information acquired by the acquisition unit, whether or not it is necessary to keep storing electricity generated by a solar cell panel in the storage battery; and a notification unit configured to, when the determination unit determines that it is not necessary to keep storing the electricity generated by the solar cell panel in the storage battery, send a notification prompting a driver to connect a charging cable to a storage apparatus outside the vehicle.

### CROSS REFERENCE TO RELATED APPLICATIONS

This application is based upon and claims the benefit of priority from Japanese patent application No. 2022-142639, filed on Sep. 8, 2022, the disclosure of which is incorporated herein in its entirety by reference.

### BACKGROUND

The present disclosure relates to a charge support system, a charge support method, and a control program.

In recent years, the effective use of electricity generated by a solar cell panel has been demanded. The related technology is disclosed, for example, in Japanese Unexamined Patent Application Publication No. 2016-100956.

Japanese Unexamined Patent Application Publication No. 2016-100956 discloses the discharge of solar power from a small storage battery to an external high-capacity storage battery when the projected amount of solar power generation exceeds the standard relative to the available capacity.

### SUMMARY

According to Japanese Unexamined Patent Application Publication No. 2016-100956, since solar power generation is automatically switched from a small storage battery to an external high-capacity storage battery using a contactless charging technology and power is discharged, solar power generation cannot be automatically switched from a small battery to an external high-capacity storage battery and power cannot be discharged in a vehicle where a contactless charging technology has not been adopted. Therefore, in Japanese Unexamined Patent Application Publication No. 2016-100956, there is a problem that the electricity generated by a solar cell panel cannot be effectively used in a vehicle where a contactless charging technology has not been adopted.

The present disclosure has been made in view of the aforementioned circumstances and an object thereof is to provide a charge support system, a charge support method, and a control program capable of effectively using electricity generated by a solar cell panel.

A charge support system according to the present disclosure is a charge support system for a vehicle including a solar cell panel attached to a vehicle body and a storage battery configured to store electricity generated by the solar cell panel, the storage battery being connected to the solar cell panel via a charging cable, the charge support system including: a detection unit configured to detect that the vehicle is scheduled to be parked for a predetermined period or longer; an acquisition unit configured to acquire information about a charging of the storage battery when the detection unit detects that the vehicle is scheduled to be parked for a predetermined period or longer; a determination unit configured to determine, based on the information acquired by the acquisition unit, whether or not it is necessary to keep storing the electricity generated by the solar cell panel in the storage battery; and a notification unit configured to, when the determination unit determines that it is not necessary to keep storing the electricity generated by the solar cell panel in the storage battery, send a notification prompting a driver to connect the charging cable to a storage apparatus outside the vehicle, the storage apparatus being different from the storage battery. The charge support system can efficiently use electricity generated by a solar cell panel even in a vehicle where a contactless charging technology has not been adopted.

A charge support method according to the present disclosure is a charge support method for a vehicle including a solar cell panel attached to a vehicle body and a storage battery configured to store electricity generated by the solar cell panel, the storage battery being connected to the solar cell panel via a charging cable, the charge support method including; detecting that the vehicle is scheduled to be parked for a predetermined period or longer; acquiring information about a charging of the storage battery when it is detected that the vehicle is scheduled to be parked for a predetermined period or longer; determining, based on the acquired information, whether or not it is necessary to keep storing the electricity generated by the solar cell panel in the storage battery; and when it is determined that it is not necessary to keep storing the electricity generated by the solar cell panel in the storage battery, sending a notification prompting a driver to connect the charging cable to a storage apparatus outside the vehicle, the storage apparatus being different from the storage battery. The charge support method can efficiently use electricity generated by a solar cell panel even in a vehicle where a contactless charging technology has not been adopted.

A control program according to the present disclosure is a control program that causes a computer to execute charge support processing for a vehicle including a solar cell panel attached to a vehicle body and a storage battery configured to store electricity generated by the solar cell panel, the storage battery being connected to the solar cell panel via a charging cable, the charge support processing including: detecting that the vehicle is scheduled to be parked for a predetermined period or longer; acquiring information about a charging of the storage battery when it is detected that the vehicle is scheduled to be parked for a predetermined period or longer; determining, based on the acquired information, whether or not it is necessary to keep storing the electricity generated by the solar cell panel in the storage battery; and when it is determined that it is not necessary to keep storing the electricity generated by the solar cell panel in the storage battery, sending a notification prompting a driver to connect the charging cable to a storage apparatus outside the vehicle, the storage apparatus being different from the storage battery. The control program can efficiently use electricity generated by a solar cell panel even in a vehicle where a contactless charging technology has not been adopted.

According to the present disclosure, it is possible to provide a charge support system, a charge support method, and a control program capable of effectively using electricity generated by a solar cell panel.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a diagram showing an example of a vehicle to which a charge support system according to a first embodiment is applied;

FIG. 2 is a block diagram showing an example of a configuration of a charge support apparatus according to the first embodiment; and

FIG. 3 is a flowchart showing operations of the charge support apparatus according to the first embodiment.

### DESCRIPTION OF EMBODIMENTS

The present disclosure will be described hereinafter with reference to an embodiment of the present disclosure. However, the following embodiment is not intended to limit the scope of the disclosure according to the claims. Further, all the components/structures described in the embodiment are not necessarily indispensable as means for solving the problem. For the clarification of the description, the following descriptions and the drawings are partially omitted and simplified as appropriate. The same elements are denoted by the same reference numerals or symbols throughout the drawings, and redundant descriptions are omitted as necessary.

### First Embodiment

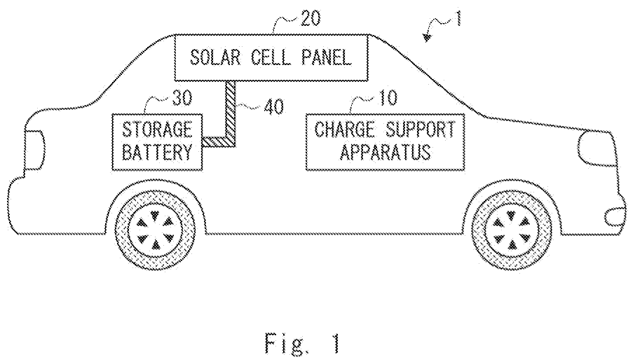

FIG. 1 is a diagram showing an example of a vehicle 1 to which a charge support system according to a first embodiment is applied. The charge support system according to the present embodiment notifies a driver to switch a charging cable from a storage battery to a storage apparatus outside a vehicle to connect it thereto when it is determined that it is not necessary to keep storing electricity generated by a solar cell panel in the storage battery. The driver who has received the notification can switch the charging cable from the storage battery to the storage apparatus outside the vehicle. By doing so, the electricity generated by a solar cell panel can be used effectively even in a vehicle where a contactless charging technology has not been adopted. The details of the above configuration will be described below.

As shown in FIG. 1, the charge support system according to the present embodiment is mounted on the vehicle 1 and includes a charge support apparatus 10, a solar cell panel 20, a storage battery 30, and a charging cable 40. The charge support apparatus 10 can also be referred to as a charge support system by itself. The charge support apparatus 10 is installed so as to monitor the status of power generated by the solar cell panel 20 and the charging status of the storage battery 30.

The solar cell panel 20 is a panel that generates electricity by sunlight and is attached to a part of a vehicle body of the vehicle 1. For example, the solar cell panel 20 is attached to a roof, a hood, a door, or the like of the vehicle 1. In the present embodiment, a case in which the solar cell panel 20 is attached to the roof of the vehicle 1 will be described as an example.

The storage battery 30 is connected to the solar cell panel 20 via the charging cable 40, thereby storing electricity generated by the solar cell panel 20. The storage battery 30 can be used as a backup power source or as a power source if the vehicle 1 is an electric vehicle.

The charging cable 40 normally connects the solar cell panel 20 to the storage battery 30. The charging cable 40 can be detached from the storage battery 30 and connected, for example, to a storage apparatus outside the vehicle. The storage apparatus outside the vehicle is installed, for example, in a parking lot of a home or in a parking lot of a convenience store.

The charge support apparatus 10 is an apparatus that determines, based on the charging status of the storage battery 30 and other factors, whether or not it is necessary to keep storing the electricity generated by the solar cell panel 20 in the storage battery 30, and notifies a driver of the determination result.

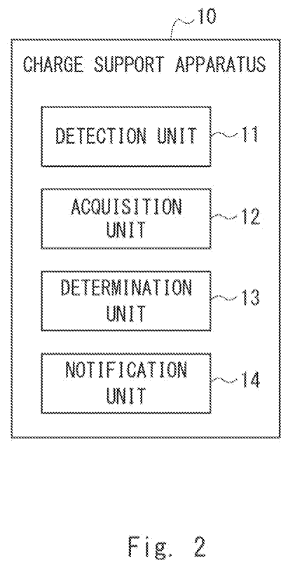

FIG. 2 is a block diagram showing an example of a configuration of the charge support apparatus 10. As shown in FIG. 2, the charge support apparatus 10 includes a detection unit 11, an acquisition unit 12, a determination unit 13, and a notification unit 14.

The detection unit 11 detects that the vehicle 1 is scheduled to be parked for a predetermined period or longer. The fact that the vehicle 1 is scheduled to be parked for a predetermined period or longer is, for example, input to the charge support apparatus 10 via a mobile terminal such as a smartphone owned by a driver or input to the charge support apparatus 10 via a dedicated operation terminal mounted on the vehicle 1. The detection unit 11 detects that the vehicle 1 is scheduled to be parked for a predetermined period or longer based on the information input via the mobile terminal owned by the driver or the dedicated operation terminal in the vehicle. Alternatively, the detection unit 11 may detect that the vehicle 1 is scheduled to be parked for a predetermined period or longer by the engine of the vehicle 1 being stopped. Note that the predetermined period can be set freely.

The acquisition unit 12 acquires information about the charging of the storage battery 30 when the detection unit 11 detects that the vehicle 1 is scheduled to be parked for a predetermined period or longer. Here, the information about the charging of the storage battery 30 is, for example, information about the charging rate of the storage battery 30, the output voltage of the solar cell panel 20 (i.e., the current charging efficiency of the storage battery 30 by the solar cell panel 20) and the weather forecast for an area in the vicinity of the vehicle used to enable predicting of a future output voltage of the solar cell panel 20 (i.e., the future charging efficiency of the storage battery 30 by the solar cell panel 20).

The determination unit 13 determines, based on the information acquired by the acquisition unit 12, whether or not it is necessary to keep storing the electricity generated by the solar cell panel 20 in the storage battery 30.

For example, the determination unit 13 determines that further charging of the storage battery 30 is unnecessary when the charging rate of the storage battery 30 is above a predetermined rate (e.g., 75%). Note that the predetermined rate can be set feely. For example, the predetermined rate may be automatically set to a charging rate sufficient to secure a power source during a period until the vehicle 1 arrives at home when the vehicle 1 is an electric vehicle.

Alternatively, the determination unit 13 may predict the transition of the charging rate of the storage battery 30 during the parking period of the vehicle 1 based on at least either the current output voltage of the solar cell panel 20 or the future output voltage of the solar cell panel 20, and determine, based on the predicted transition status of the charging rate of the storage battery 30, whether or not further charging of the storage battery 30 is required. For example, when it is predicted that the storage battery 30 will be fully charged early in the parking period of the vehicle 1 and the storage battery 30 will not be charged from the middle to the late parking period, the determination unit 13 determines that further charging of the storage battery 30 is not required since the electricity generated by the solar cell panel 20 is wasted.

When the determination unit 13 determines that it is not necessary to keep storing electricity generated by the solar cell panel 20 in the storage battery 30, the notification unit 14 sends a notification prompting a driver to switch the charging cable 40 from the storage battery 30 to a storage apparatus outside the vehicle to connect it thereto. Note that the notification unit 14 may further notify the driver of at least either the charging rate of the storage battery 30 or the charging rate of the storage battery 30 after the parking period has elapsed. The content of the notification sent by the notification unit 14 is, for example, output by voice from a speaker in the vehicle or displayed on a monitor in the vehicle or on a mobile terminal owned by a user.

The driver who has found the content of the notification can switch the charging cable 40 from the storage battery 30 to a storage apparatus outside the vehicle 1 to connect it thereto. By doing so, the electricity generated by a solar cell panel can be used effectively even in a vehicle where a contactless charging technology has not been adopted.

### (Operations of the Charge Support Apparatus 10)

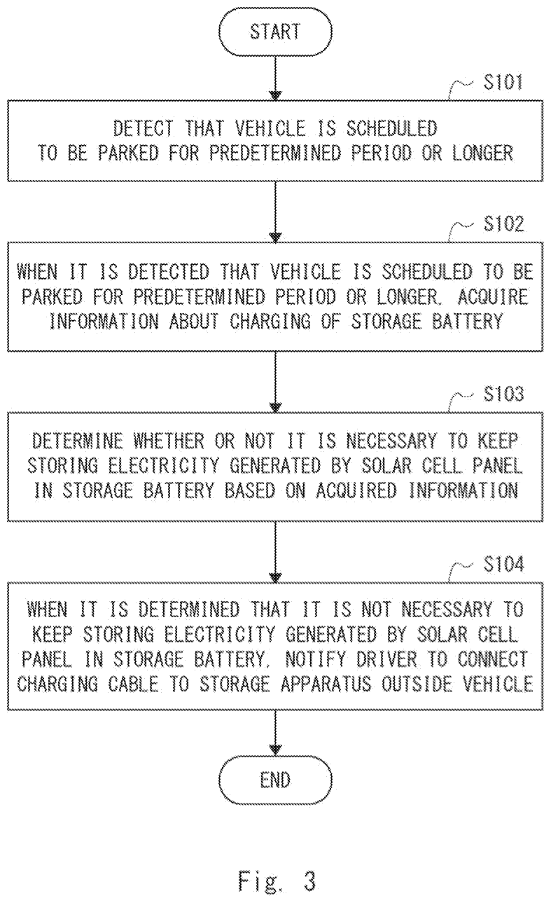

Next, the operations of the charge support apparatus 10 will be described with reference to FIG. 3. FIG. 3 is a flowchart showing the operations of the charge support apparatus 10.

First, the charge support apparatus 10 detects that the vehicle 1 is scheduled to be parked for a predetermined period or longer, for example, by information input via a mobile terminal owned by a driver or an operation terminal in the vehicle (Step S101). When the charge support apparatus 10 detects that the vehicle 1 is scheduled to be parked for a predetermined period or longer, it acquires information about the charging of the storage battery 30 (e.g., the charging rate of the storage battery 30) (Step S102). Then, based on the acquired information, the charge support apparatus 10 determines whether or not it is necessary to keep storing the electricity generated by the solar cell panel 20 in the storage battery 30 (Step S103). For example, the charge support apparatus 10 determines that further charging of the storage battery 30 is unnecessary when the charging rate of the storage battery 30 is above a predetermined rate. Then, when the charge support apparatus 10 determines that it is not necessary to keep storing the electricity generated by the solar cell panel 20 in the storage battery 30, it sends a notification prompting the driver to switch the charging cable 40 from the storage battery 30 to a storage apparatus outside the vehicle to connect it thereto (Step S104).

As described above, the charge support system according to the present embodiment notifies a driver to switch a charging cable from the storage battery 30 to a storage apparatus outside a vehicle to connect it thereto when it is determined that it is not necessary to keep storing electricity generated by the solar cell panel 20 in the storage battery 30. The driver who has received the notification can switch the charging cable 40 from the storage battery 30 to the storage apparatus outside the vehicle. By doing so, the electricity generated by the solar cell panel 20 can be used effectively even in a vehicle where a contactless charging technology has not been adopted.

It should be noted that the charge support system according to the present embodiment may further include a mechanism in which an incentive (money, points, complimentary tickets, etc.) is given to a driver in accordance with the amount of electricity stored in a storage apparatus outside the vehicle. In this case, for example, the charge support apparatus 10 may further include a management unit that manages an incentive in accordance with the amount of electricity stored in an external storage apparatus. The management unit manages the destination of the incentive etc. By doing the above, it is expected that a driver will aggressively charge a storage apparatus outside the vehicle.

The present disclosure is not limited to the above-described embodiment and may be changed as appropriate without departing from the scope and spirit of the present disclosure. Further, the present disclosure relates to use of a solar photovoltaic panel, and contributes to carbon neutrality, decarbonization, and Sustainable Development Goals (SDGs).

Further, in the present disclosure, it is possible to implement all or part of processing performed by the charge support apparatus 10 by causing a Central Processing Unit (CPU) to execute a computer program.

The program described above includes a set of instructions (or software code) for having the computer perform one or more functions described in the embodiment when read into the computer. The program may be stored on a non-temporary computer-readable medium or a physical storage medium. By way of example, but not limitation, a computer-readable medium or a physical storage medium includes RAM (Random-Access Memory), ROM (Read-Only Memory), flash memory, SSD (Solid-State Drive) or other memory technology, CD-ROM, DVD (Digital Versatile Disc), Blu-ray® disk or other optical disk storage, magnetic cassette, magnetic tape, magnetic disk storage or other magnetic storage device. The program may be transmitted on a temporary computer-readable medium or communication medium. By way of example and not limitation, a temporary computer-readable medium or communication medium may include an electrical, optical, acoustic or other form of propagating signal.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A charge support system for a vehicle comprising a solar cell panel attached to a vehicle body and a storage battery configured to store electricity generated by the solar cell panel, the storage battery being connected to the solar cell panel via a charging cable, the charge support system comprising:
a detection unit configured to detect that the vehicle is scheduled to be parked for a predetermined period or longer;
an acquisition unit configured to acquire information about a charging of the storage battery when the detection unit detects that the vehicle is scheduled to be parked for a predetermined period or longer;
a determination unit configured to determine, based on the information acquired by the acquisition unit, whether or not it is necessary to keep storing the electricity generated by the solar cell panel in the storage battery; and
a notification unit configured to, when the determination unit determines that it is not necessary to keep storing the electricity generated by the solar cell panel in the storage battery, send a notification prompting a driver to connect the charging cable to a storage apparatus outside the vehicle, the storage apparatus being different from the storage battery.

2. The charge support system according to claim 1, wherein the acquisition unit further acquires at least either information about an output voltage of the solar cell panel or information about a weather forecast for an area in the vicinity of the vehicle for enabling predicting of a future output voltage of the solar cell panel.

3. The charge support system according to claim 1, wherein the detection unit detects that the vehicle is scheduled to be parked for a predetermined period or longer based on at least either information input via a mobile terminal owned by the driver or information input via an operation terminal mounted on the vehicle.

4. A charge support method for a vehicle comprising a solar cell panel attached to a vehicle body and a storage battery configured to store electricity generated by the solar cell panel, the storage battery being connected to the solar cell panel via a charging cable, the charge support method comprising:
detecting that the vehicle is scheduled to be parked for a predetermined period or longer;
acquiring information about a charging of the storage battery when it is detected that the vehicle is scheduled to be parked for a predetermined period or longer;
determining, based on the acquired information, whether or not it is necessary to keep storing the electricity generated by the solar cell panel in the storage battery; and
when it is determined that it is not necessary to keep storing the electricity generated by the solar cell panel in the storage battery, sending a notification prompting a driver to connect the charging cable to a storage apparatus outside the vehicle, the storage apparatus being different from the storage battery.

5. A non-transitory computer readable medium storing a control program for causing a computer to execute charge support processing for a vehicle comprising a solar cell panel attached to a vehicle body and a storage battery configured to store electricity generated by the solar cell panel, the storage battery being connected to the solar cell panel via a charging cable, the charge support processing comprising:
detecting that the vehicle is scheduled to be parked for a predetermined period or longer;
acquiring information about a charging of the storage battery when it is detected that the vehicle is scheduled to be parked for a predetermined period or longer;
determining, based on the acquired information, whether or not it is necessary to keep storing the electricity generated by the solar cell panel in the storage battery; and
when it is determined that it is not necessary to keep storing the electricity generated by the solar cell panel in the storage battery, sending a notification prompting a driver to connect the charging cable to a storage apparatus outside the vehicle, the storage apparatus being different from the storage battery.
